(19) United States
(12) Patent Application Publication
(10) Pub. No.: US 2026/0106285 A1
(43) Pub. Date: Apr. 16, 2026

(54) SECONDARY BATTERY AND ELECTRONIC DEVICE INCLUDING SECONDARY BATTERY

(71) Applicant: SAMSUNG SDI CO., LTD., Yongin-Si (KR)

(72) Inventor: Hyojin LIM, Yongin-Si (KR)

(21) Appl. No.: 19/336,149

(22) Filed: Sep. 22, 2025

(30) Foreign Application Priority Data
Oct. 16, 2024 (KR) 10-2024-0141202

(51) Int. Cl. H01M 50/186; H01M 50/119; H01M 50/166; H01M 50/627

(52) U.S. Cl. CPC H01M 50/186; H01M 50/119; H01M 50/166; H01M 50/627; H01M 2220/30

(57) ABSTRACT

A secondary battery includes an electrode assembly that includes a first electrode, a second electrode, and a separator; a lower case accommodating the electrode assembly; an upper case coupled to the lower case; a first adhesive member between the lower case and the electrode assembly such that the lower case and the electrode assembly are adhered to each other; and a second adhesive member between the upper case and the electrode assembly such that the upper case and the electrode assembly are adhered to each other. Materials of the first adhesive member and the second adhesive member are different from each other.

### CROSS-REFERENCE TO RELATED APPLICATION

The present application claims priority to and the benefit of Korean Patent Application No. 10-2024-0141202, filed in the Korean Intellectual Property Office on Oct. 16, 2024, the entire disclosure of which is hereby incorporated by reference.

### BACKGROUND

### 1. Field

The present disclosure relates to a secondary battery and an electronic device including the secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

For example, a secondary battery may be manufactured by inserting an electrode assembly into a case, injecting an electrolyte into the case, and then sealing the case with a cap assembly or an upper case. If the electrode assembly is not adhered to the inside of the case and a position of the electrode assembly is not fixed, there may be a problem in which the electrode assembly moves inside the case due to external impact or falling of the battery. For example, the electrode assembly may be damaged, or a quality or stability of the secondary battery may deteriorate.

The above information disclosed in this Background section is for enhancement of understanding of the background of the present disclosure, and therefore, it may contain information that does not constitute related (or prior) art.

### SUMMARY

The present disclosure is intended to solve the above problem, and an object of the present disclosure is to provide a secondary battery and an electronic device including the secondary battery for solving the above problem.

These and other aspects and features of the present disclosure will be described in or will be apparent from the following description of embodiments of the present disclosure.

In order to solve the above technical problems, according to some embodiments of the present disclosure, there is provided a secondary battery including: an electrode assembly that includes a first electrode, a second electrode, and a separator; a lower case accommodating the electrode assembly; an upper case coupled to the lower case; a first adhesive member between the lower case and the electrode assembly such that the lower case and the electrode assembly are adhered to each other; and a second adhesive member between the upper case and the electrode assembly such that the upper case and the electrode assembly are adhered to each other. Materials of the first adhesive member and the second adhesive member are different from each other.

According to some embodiments of the present disclosure, each of the first adhesive member and the second adhesive member may be on an inner side of the electrode assembly in a width direction and a longitudinal direction of the electrode assembly.

According to some embodiments of the present disclosure, a center of the electrode assembly in the width direction may be substantially aligned with a center of each of the first adhesive member and the second adhesive member in the width direction.

According to some embodiments of the present disclosure, the first adhesive member may include a binder, and the second adhesive member may include an OPS tape.

According to some embodiments of the present disclosure, an electrolyte injection port may be in the lower case, and the center of the second adhesive member and the electrolyte injection port may be on opposite sides of the center of the electrode assembly.

According to some embodiments of the present disclosure, the second adhesive member and the electrolyte injection port may be on opposite sides of the center of the electrode assembly along a longitudinal direction or a width direction of the electrode assembly.

According to some embodiments of the present disclosure, the second adhesive member may be inwardly spaced from an upper end of the electrode assembly by a first length along the longitudinal direction of the electrode assembly, the second adhesive member may be inwardly spaced from a lower end of the electrode assembly by a second length along the longitudinal direction of the electrode assembly, the second adhesive member may be inwardly spaced from left and right ends of the electrode assembly by a third length along the width direction of the electrode assembly, and the first length and the second length may be longer than the third length.

According to some embodiments of the present disclosure, the secondary battery may further include an upper tape and a lower tape that are respectively attached to an upper portion and a lower portion of the electrode assembly along the longitudinal direction of the electrode assembly. The second adhesive member may not overlap the upper tape and the lower tape in a thickness direction.

According to some embodiments of the present disclosure, the first adhesive member may include an OPS tape, and the second adhesive member may include a binder.

According to some embodiments of the present disclosure, an electrolyte injection port may be in the lower case, and the center of the first adhesive member and the electrolyte injection portion may be on opposite sides of the center of the electrode assembly.

According to some embodiments of the present disclosure, the first adhesive member and the electrolyte injection portion may be on opposite sides of the center of the electrode assembly along a longitudinal direction or a width direction of the electrode assembly.

According to some embodiments of the present disclosure, the first adhesive member may inwardly spaced from an upper end of the electrode assembly by a first length along the longitudinal direction of the electrode assembly, the first adhesive member may be inwardly spaced from a lower end of the electrode assembly by a second length along the longitudinal direction of the electrode assembly, the first adhesive member may be inwardly spaced from left and right ends of the electrode assembly by a third length along the width direction of the electrode assembly, and the first length and the second length may be longer than the third length.

According to some embodiments of the present disclosure, the secondary battery may further include an upper tape and a lower tape that are respectively attached to an upper portion and a lower portion of the electrode assembly along the longitudinal direction of the electrode assembly. The first adhesive member may not overlap the upper tape and the lower tape in a thickness direction.

According to some embodiments of the present disclosure, a thickness of the first adhesive member or the second adhesive member may be in a range from approximately 3μ to approximately 5 μm, and a thickness of the other of the first adhesive member or the second adhesive member may be approximately 50 μm.

According to some embodiments of the present disclosure, electrode terminals may be on the lower case, and the secondary battery may include an insulator between the electrode terminals and the electrode assembly.

According to some embodiments of the present disclosure, the lower case and the upper case may include stainless steel (SUS).

According to some embodiments of the present disclosure, the upper case may include one or more screw tabs configured to be fastened by screws.

In order to solve the above technical problems, according to some embodiments of the present disclosure, there is provided an electronic device including: an operation unit that performs predetermined operations; a housing accommodating the operation unit therein such that the operation unit is fixed; and a secondary battery fixed inside the housing and configured to supply power to the operation unit, in which the secondary battery includes: an electrode assembly; a lower case accommodating the electrode assembly; an upper case coupled to the lower case; a first adhesive member between the lower case and the electrode assembly such that the lower case and the electrode assembly are adhered to each other; and a second adhesive member between the upper case and the electrode assembly such that the upper case and the electrode assembly are adhered to each other, and materials of the first adhesive member and the second adhesive member are different from each other.

According to some embodiments of the present disclosure, the upper case may include one or more screw tabs configured to be fastened by screws and the one or more screw tabs may be in the housing.

According to some embodiments of the present disclosure, the electronic device may further include: a double-sided tape between the secondary battery and the housing such that the secondary battery is mounted in the housing.

According to some embodiments of the present disclosure, different types of adhesive members are applied to both sides of the electrode assembly, and thus the ability of the secondary battery to withstand a fall impact can be improved with a structure that is advantageous in terms of thickness, adhesive strength, and attachment time.

According to some embodiments of the present disclosure, a packing ratio in the cell can be increased. Thus, in a high power charging (HPC) process, a binding force can be increased, and therefore, it is possible to prevent (or at least mitigate) lithium precipitation.

According to some embodiments of the present disclosure, the electrode assembly and the adhesive member overlap each other in the longitudinal direction or the thickness direction. Thus, a contact area between the electrode assembly and the adhesive member can be maximized (or at least increased), and the adhesive strength can be improved. Therefore, it is possible to solve a problem in which the electrode assembly moves inside the case due to a falling impact of the battery.

According to some embodiments of the present disclosure, screw tabs may be included instead of side tapes. Because the side tapes are not included, there is no limitation on a type of the adhesive member. Further, even in a case where the screw tabs are attached to the same surface as the adhesive member, when an external impact or falling of the battery occurs, it is possible to prevent (or at least mitigate) the electrode plates from being damaged due to the mechanical strength of the stainless steel.

According to some embodiments of the present disclosure, a distance between the center of the second adhesive member and the center of the electrode assembly can be increased, and thus, impregnation performance of the electrolyte can be improved. Therefore, it is possible to prevent (or at least mitigate) curling and folding of the OPS tape.

According to some embodiments of the present disclosure, a center of the insulator may be substantially aligned with the center of the electrode assembly in the width direction, and an area of the insulator may be substantially aligned with an area of the side of the electrode assembly facing the insulator. By applying a configuration for doubly preventing movement of the electrode assembly in the longitudinal direction together with double-sided adhesive members applied to the electrode assembly, it is possible to prevent (or at least mitigate) a short circuit due to movement of the electrode assembly, and it is thereby possible to further reduce movement of the electrode assembly inside the cell compared to a related art pouch cell.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is an exploded perspective view illustrating an example of a secondary battery according to some embodiments of the present disclosure.

FIG. 2 is a bottom view and a top view illustrating an example of an electrode assembly according to some embodiments of the present disclosure.

FIG. 3 is a bottom view and a top view illustrating an example of an electrode assembly according to some embodiments of the present disclosure.

FIG. 4 is a projection view of a case for explaining a size of an adhesive member according to some embodiments of the present disclosure.

FIG. 5 is a perspective view for explaining attachment positions of tapes according to some embodiments of the present disclosure.

FIG. 6 is a projection view of a case for explaining an attachment position of an adhesive member according to some embodiments of the present disclosure.

FIG. 7 is a projection view of a case for explaining a size of an adhesive member according to some embodiments of the present disclosure.

FIG. 8 is a projection view of a case illustrating an example of an insulator according to some embodiments of the present disclosure.

FIG. 9 is a diagram schematically illustrating a battery electronic device according to some embodiments of the present disclosure.

FIG. 10 is a diagram illustrating a secondary battery disposed in the battery electronic device according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, sizes and relative sizes of areas illustrated in the drawings may be exaggerated for clarity of explanation. That is, the sizes illustrated in the drawings are only for convenience of understanding, and are not limited thereto. Further, identical reference numerals throughout the specification refer to identical components.

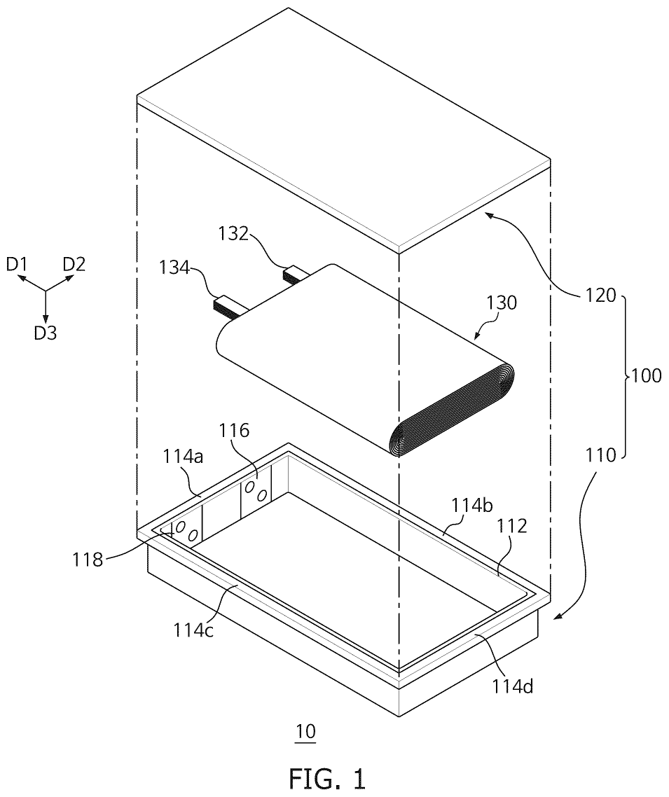

FIG. 1 is an exploded perspective view illustrating an example of a secondary battery 10 according to some embodiments of the present disclosure.

Referring to FIG. 1, a secondary battery 10 may include at least one or more electrode assemblies 130 and a case 100 in which the one or more electrode assemblies 130 are accommodated. The electrode assembly may be wound or stacked in a state in which a separator, which is an insulator, is interposed between a positive electrode and a negative electrode.

A positive electrode plate and a negative electrode plate may include a composite portion, which is a region obtained by applying an active material on a current collector formed of a thin metal foil, and a non-coated portion, which is a region on which an active material is not coated.

According to some embodiments, the positive electrode plate and the negative electrode plate may be stacked after a separator, which is an insulator, is interposed therebetween. In one or more embodiments, the electrode assembly 130 may include a plurality of sheets of positive electrode plates and negative electrode plates alternately stacked with a separator interposed between. However, the present disclosure is not limited thereto, and the electrode assembly 130 may be wound in a form in which the positive electrode plate and the negative electrode plate are separated by the separator.

The case 100 may form an overall appearance of the secondary battery. According to some embodiments, the case 100 may be formed of (or include) stainless use steel (SUS). In other embodiments, the case 100 may be formed of (or include) a conductive metal such as aluminum, an aluminum alloy, or nickel-plated steel. Further, the case 100 may include a lower case 110 in which the electrode assembly 130 is accommodated and an upper case 120 that seals the lower case 110. Electrode terminals 116 and 118 may be formed on one side of the lower case 110.

The lower case 110 of the case 100 may have an opening formed on one side of the lower case 110 on which the electrode terminals 116 and 118 are formed. An accommodating portion 112 for accommodating the electrode assembly 130 may be formed at the approximate central area of the lower case 110 by press processing or the like. Further, flanges (114a, 114b, 114c, and 114d) may be formed at upper edges of the accommodating portion 112 in four directions (e.g., the flanges 114a, 114b, 114c, and 114d extend around the periphery of the accommodating portion 112).

According to some embodiments, the case 100 may be formed by coupling (e.g., bonding) the lower case 110 and the upper case 120 to each other. For example, the case 100 may be formed by metal bonding (for example, welding, brazing, soldering, or the like) between the lower case 110 and the upper case 120. The upper case 120 may be bonded to the flanges 114a, 114b, 114c, and 114d of the lower case 110 to seal the opening of the lower case 110.

According to some embodiments, the upper case 120 may include one or more screw tabs to be fastened with screws. For example, two screw tabs may be respectively formed on an upper side and a lower side of the upper case. A total of four screw tabs may be formed to be adjacent to each corner of the upper case.

The positive electrode terminal 116 that is electrically connected to a positive electrode tab 132 of the electrode assembly 130 and the negative electrode terminal 118 that is electrically connected to a negative electrode tab 134 of the electrode assembly 130 may be connected to the lower case 110. In one or more embodiments, the electrode terminals 116 and 118 may be on at least one side of the lower case 110. The positions of the electrode terminals 116 and 118 according to the present disclosure are not limited to the positions illustrated in FIG. 1 and may have any other suitable locations or positions.

An electrolyte injection port, a vent portion, and the like may be further formed at the side of the lower case 110 at which the electrode terminals 116 and 118 are located. In one or more embodiments, the electrolyte injection port and the vent portion may be on the same surface as the surface on which the electrode terminals 116 and 118 are located in the lower case 110.

In the electrode assembly 130, the positive electrode tab 132 that is electrically connected to the non-coated portion for the positive electrode may be on one side of the positive electrode plate, and the negative electrode tab 134 that is electrically connected to the non-coated portion for the negative electrode may be on one side of the negative electrode plate. The positive electrode tab 132 may be at a specific position on one side of the positive electrode plate, and the negative electrode tab 134 may be at a specific position on one side of the negative electrode plate.

The positive electrode tab 132 and the negative electrode tab 134 may extend in the same direction from one side of the electrode assembly 130. Further, a plurality of positive electrode tabs 132 on a plurality of positive electrode plates may be connected to each other to form a first current collecting tab. Further, a plurality of negative electrode tabs 134 on a plurality of negative electrode plates may be connected to each other to form a second current collecting tab.

The first collecting tab and the second collecting tab may be at different positions on one side of the electrode assembly 130. For example, the first collecting tab and the second collecting tab may be spaced apart from each other on one side of the electrode assembly 130. In other embodiments, the first collecting tab may be on one side of the electrode assembly 130, and the second collecting tab may be on the other side of the electrode assembly 130 (e.g., the first and second collecting tabs may be on opposite sides of the electrode assembly 130). Therefore, the first collecting tab and the second collecting tab may not be in contact with each other.

According to some embodiments, the positive electrode tab 132 or the first current collecting tab connected to the positive electrode plate may be electrically connected to the electrode terminal 116. The electrode terminal may be a positive electrode terminal. In some embodiments, the negative electrode tab 134 or the second current collecting tab connected to the negative electrode plate may be electrically connected to the electrode terminal 118.

The secondary battery may be a lithium secondary battery, a sodium secondary battery, or the like. However, the scope of the present disclosure is not limited thereto, and the secondary battery may be any suitable type or kind of battery that can repeatedly provide electricity by charging and discharging.

The configuration of the secondary battery illustrated in FIG. 1 is only an example. In some embodiments, other configurations may be further included in addition to the illustrated configurations, and some configurations may be omitted. Further, a shape, a positional relationship, and the like of each component of the secondary battery illustrated in FIG. 1 may be appropriately changed.

D1, D2, and D3 illustrated in FIG. 1 may respectively indicate a longitudinal direction, a width direction, and a thickness direction of the secondary battery 10 or the configuration of the secondary battery 10 (for example, the case 100, the electrode assembly 130, or the like).

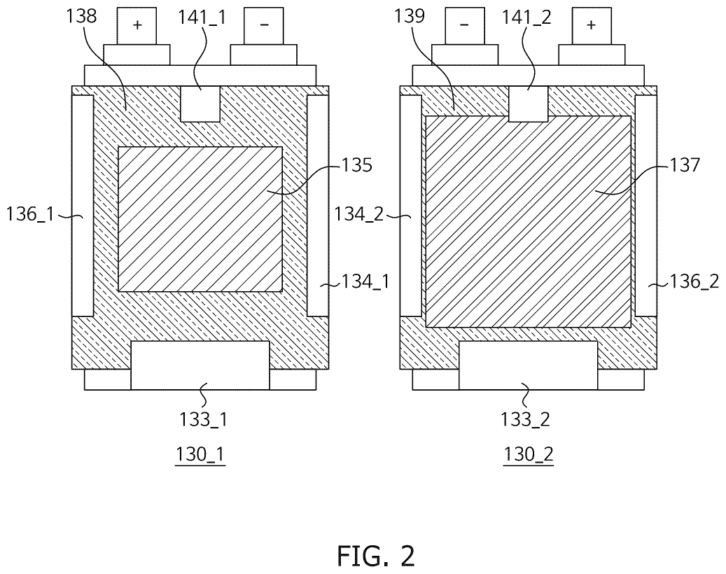

FIG. 2 is a bottom view 130_1 and a top view 130_2 illustrating an example of the electrode assembly 130 according to some embodiments of the present disclosure.

As illustrated in FIG. 2, a first adhesive member 137 may be between the upper case 120 and an upper surface 139 of the electrode assembly 130, and a second adhesive member 135 may be between the lower case 110 and a lower surface 138 of the electrode assembly 130.

Materials of the first adhesive member 137 and the second adhesive member 135 may be different from each other. According to some embodiments, the first adhesive member 137 may include a binder, and the second adhesive member 135 may include an OPS tape.

The binder may have an advantage that a thickness of the binder is relatively thin and has a thickness in a range from approximately 3 μm to approximately 5 μm, but it may take a long time to apply and harden the binder. The OPS tape may have an advantage that adhesive strength is high and an attachment time is short as compared with the binder, but there may be a limitation that the OPS tape is thick. With regard to these characteristics, the secondary battery 10 according to the present disclosure may apply different types of adhesives for the upper surface 139 and the lower surface 138 of the electrode assembly 130. Therefore, it is possible to improve not only characteristics such as a thickness, adhesive strength, and an attachment time, but also falling characteristics (i.e., the ability of the secondary battery 10 to withstand a fall impact).

According to some embodiments, the secondary battery 10 may include an upper tape 141 and a lower tape 133, the upper tape 141 being attached to a surface of the electrode assembly 130 on which the electrode tabs 132, 134 of the electrode assembly 130 are disposed along the longitudinal direction of the electrode assembly 130, and the lower tape 133 being attached to an opposite surface of the electrode assembly 130. Further, according to some embodiments, the secondary battery 10 may further include side tapes 134 and 136 attached to sides of the electrode assembly 130 along a width direction of the electrode assembly 130, but the present disclosure is not limited thereto.

In some embodiments, lengths of the side tapes 134 and 136 in the longitudinal direction may be equal (or substantially equal) to lengths of the sides of the electrode assembly 130 in the longitudinal direction.

With this configuration, a packing ratio in the cell may be increased. Thus, in a high power charging (HPC) process, a binding force may be increased, and therefore, it is possible to obtain an effect of preventing (or at least mitigating) lithium precipitation.

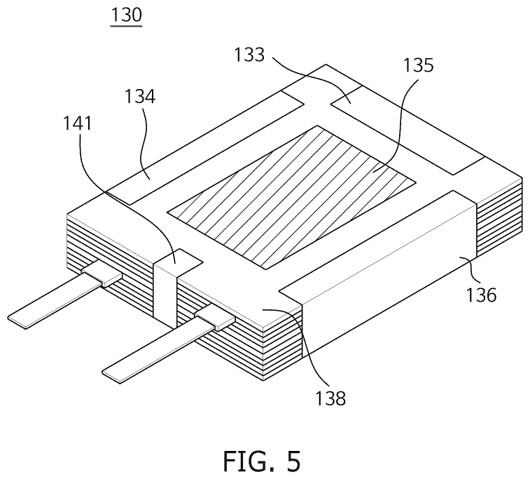

FIG. 5 is a perspective view for explaining attachment positions of the tapes according to some embodiments of the present disclosure.

FIG. 5 illustrates an embodiment in which the upper tape 141, the lower tape 133, and the side tapes 134 and 136 are attached to the electrode assembly 130 of the stacking-type secondary battery. The electrode assembly 130 may be formed by sequentially stacking the first electrode, the separator, and the second electrode. The lower tape 133 may be attached to the lower surface of the electrode assembly 130. In some embodiments, the separator of the electrode assembly 130 may be prevented (or at least mitigated) from being rolled into the electrode assembly 130 by the lower tape 133.

In some embodiments, only the lower tape 133 and the upper tape 141 may be attached. In some embodiments, the side tapes 134 and 136 may be attached. In some embodiments, the side tapes 134 and 136 may not be provided. However, the present disclosure is not limited thereto.

In this configuration, in an embodiment in which the side tapes 134 and 136 are applied to the same surface as the adhesive member (for example, the OPS tape), the electrode plates may be damaged. In order to prevent (or at least mitigate) the damage, screw tabs may be included instead of the side tapes 134 and 136. In an embodiment where screw tabs are included instead of the side tapes 134 and 136, because the side tapes 134 and 136 are not included, there may be no limitation on a type of the adhesive member. Further, even in an embodiment in which the screw tabs are attached to the same surface as the adhesive member, when external impact or falling of the battery occurs, the electrode plates may be prevented (or at least mitigated) from being damaged by the mechanical strength of the stainless steel.

According to some embodiments, the second adhesive member 135 may be on an inner side of the electrode assembly 130 in the width direction and the longitudinal direction. A center of the electrode assembly 130 in the width direction may be aligned (or substantially aligned) with a center of the second adhesive member 135 in the width direction. In some embodiments, the center of the second adhesive member 135 may not be aligned with the center of the first adhesive member 127. The first adhesive member 137 may not be at the center of the upper surface 139 of the electrode assembly 130, and the second adhesive member 135 may not be at the center of the lower surface 138 of the electrode assembly 130.

In some embodiments, the center of the electrode assembly 130 in the longitudinal direction may be aligned (or substantially aligned) with the center of the second adhesive member 135 in the longitudinal direction.

In the above description, the second adhesive member 135 attached to the lower surface 138 of the electrode assembly 130 has been described. However, the present disclosure is not limited thereto, and the upper tape 141, the lower tape 133, and the side tapes 134 and 136 may also be attached to the upper surface 139 of the electrode assembly 130.

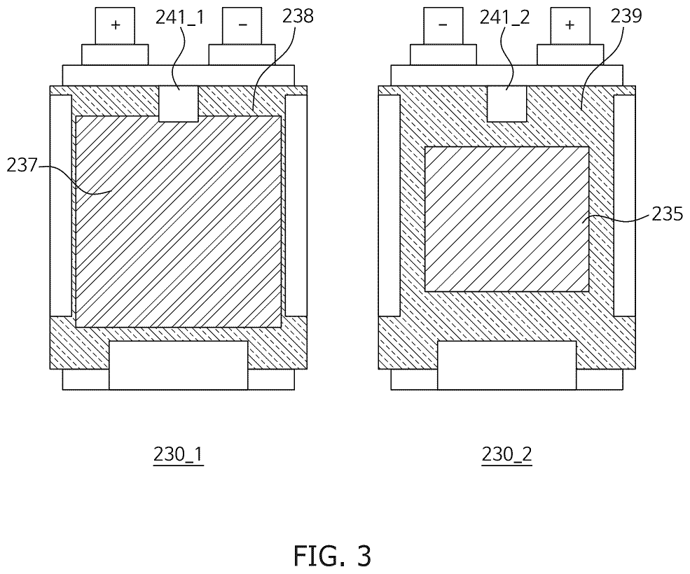

FIG. 3 is a bottom view 230_1 and a top view 230_2 illustrating an example of an electrode assembly 230 according to some embodiments of the present disclosure.

As illustrated in FIG. 3, a first adhesive member 235 may be between the upper case 120 and an upper surface 239 of the electrode assembly 230, and a second adhesive member 237 may be between the lower case 110 and a lower surface 238 of the electrode assembly 230.

Materials of the first adhesive member 235 and the second adhesive member 237 may be different from each other. According to some embodiments, the first adhesive member 235 may include an OPS tape, and the second adhesive member 237 may include a binder.

According to some embodiments, a thickness of the first adhesive member 235 may be approximately 50 μm, and a thickness of the second adhesive member 237 may be in a range from approximately 3 μm to approximately 5 μm. However, the present disclosure is not limited thereto.

Comparing FIG. 2 and FIG. 3, FIG. 2 may illustrate an example in which the first adhesive member 137 includes a binder and the second adhesive member 135 includes an OPS tape, and FIG. 3 may illustrate an example in which the first adhesive member 235 includes an OPS tape and the second adhesive member 237 includes a binder.

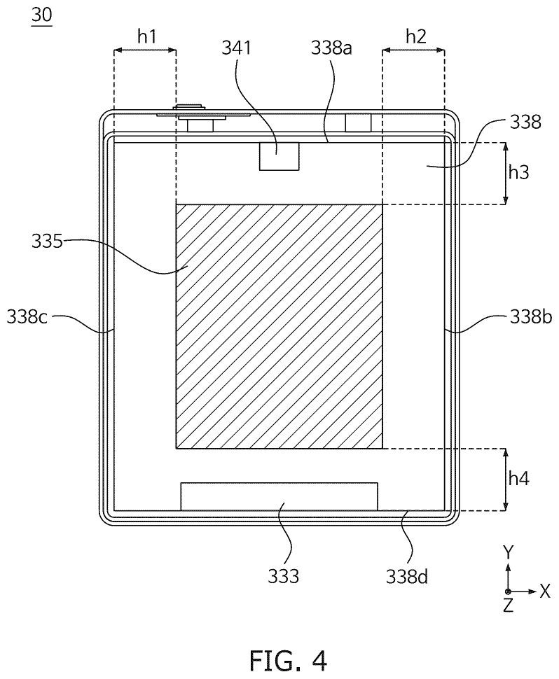

FIG. 4 is a projection view 30 of the case for explaining a size of the adhesive member according to some embodiments of the present disclosure.

As illustrated in FIG. 4, one side 338 of the electrode assembly may include an upper end 338a, a lower end 338d, a left end 338c, and a right end 338b. An upper tape 341 and a lower tape 333 may be at the upper end 338a and the lower end 338d, respectively. An adhesive member 335 may be on one side 338 of the electrode assembly. The adhesive member 335 may have a spacing distance (e.g., a gap) from each end 338a-338d, and a material of the adhesive member 335 may include an OPS tape. In one or more embodiments, one side 338 of the electrode assembly may be an upper surface or a lower surface of the electrode assembly.

According to some embodiments, the adhesive member 335 may be inwardly spaced from the upper end 338a of the electrode assembly by a first length h3 along the longitudinal direction (y-axis direction) of the electrode assembly, and may be inwardly spaced from the lower end 338d of the electrode assembly by a second length h4 along the longitudinal direction (y-axis direction) of the electrode assembly. The adhesive member 335 may be inwardly spaced from the left end 338c of the electrode assembly by a third length h1 along the width direction (x-axis direction) of the electrode assembly, and may be inwardly spaced from the right end 338b of the electrode assembly by a third length h2 along the width direction (x-axis direction) of the electrode assembly.

In some embodiments, the first length h3, the second length h4, and the third lengths h1 and h2 may be the same (or substantially the same), may be different from each other, or may be only partially different (e.g., different in some respects and the same in some respects).

In some embodiments, the first length h3 and the second length h4 may be longer than the third lengths h1 and h2. With regard to the third lengths h1 and h2, the length h1 from the left end 338c and the length h2 from the right end 338b may be the same (or substantially the same), or may be different from each other.

According to some embodiments, the first length h3, the second length h4, and the third lengths h1 and h2 may be set to be longer than the length of the tape in the longitudinal direction (y-axis direction).

According to some embodiments, the secondary battery may further include the upper tape 341 and the lower tape 333 that are attached to the upper end 338a and the lower end 338d, respectively, along the longitudinal direction (y-axis direction) of the electrode assembly. In some embodiments, the adhesive member 335 may not overlap the upper tape 341 and the lower tape 333 in the thickness direction (z-axis direction). In some embodiments, the adhesive member 335 may overlap the upper tape 341 and/or the lower tape 333 in the longitudinal direction (y-axis direction). With this configuration, a part of the adhesive member 335 may higher than a bottom height of the tape 341, 333. Thus, a contact area between the electrode assembly and the adhesive member 335 may be maximized, and the adhesive strength may be improved. In another embodiment, the adhesive member 335 may not overlap the upper tape 341 and the lower tape 333 in the longitudinal direction (y-axis direction) or the thickness direction (z-axis direction).

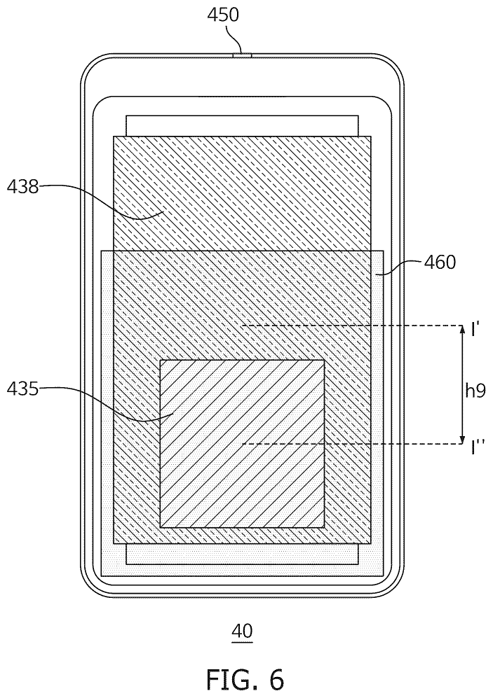

FIG. 6 is a projection view 40 of the case for explaining the attachment position of the adhesive member according to some embodiments of the present disclosure.

As illustrated in FIG. 6, an electrolyte injection port 450 may be in one side of the lower case. The electrolyte injection port 450 may be between the first electrode terminal and the second electrode terminal, but the present disclosure is not limited thereto. The electrolyte injection port 450 may be on any area of a first side or another side of the lower case 110. An electrolyte may be injected through the electrolyte injection port 450, and an area 460 filled with the electrolyte may be thereby formed.

According to some embodiments, the center I″ of the adhesive member 435 and the electrolyte injection port 450 may be located on opposite sides of the center I′ of the electrode assembly. In one or more embodiments, the adhesive member 435 may be an OPS tape. However, the present disclosure is not limited thereto.

According to some embodiments, along the longitudinal direction (y-axis direction) or the width direction (x-axis direction) of the electrode assembly, the adhesive member 435 and the electrolyte injection port 450 may be located on opposite sides of the center I′ of the electrode assembly. In some embodiments, a boundary of the adhesive member 435 may be located opposite to the electrolyte injection port 450 with respect to the center I′ of the electrode assembly.

In some embodiments, the OPS tape may have an adhesive property by reaction with the electrolyte, and the OPS tape may curl and fold in a portion that is not impregnated with the electrolyte. With this configuration, a distance h9 between the center I″ of the adhesive member 435 and the center I′ of the electrode assembly may be increased, and thus, impregnation performance of the electrolyte can be improved. In an embodiment in which the position of the adhesive member 435 is changed, dropping impact may decrease. Thus, the width of the adhesive member 435 may be increased. Further, the electrolyte injection direction may vary depending on the model, and thus, the attachment position of the adhesive member 435 may be changed according to the electrolyte injection direction. According to some embodiments of the present disclosure, the adhesive member 435 may be on the opposite side of the secondary battery as the electrolyte injection port regardless of the model, and thus, the impregnation performance of the electrolyte can be improved.

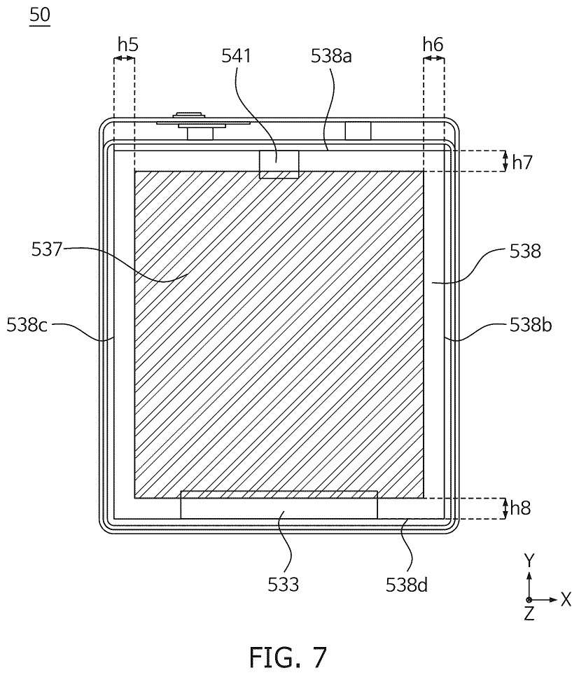

FIG. 7 is a projection view 50 of the case for explaining a size of the adhesive member according to some embodiments of the present disclosure.

As illustrated in FIG. 7, one side 538 of the electrode assembly may include an upper end 538a, a lower end 538d, a left end 538c, and a right end 538b. An upper tape 541 and a lower tape 533 may be at the upper end 538a and the lower end 538d, respectively. An adhesive member 537 may be on one side 538 of the electrode assembly. The adhesive member 537 may have a spacing distance (e.g., a gap) from each end 538a-538d, and a material of the adhesive member 537 may include a binder. In one or more embodiments, one side 538 of the electrode assembly may be an upper surface or a lower surface of the electrode assembly.

According to some embodiments, the adhesive member 537 may be inwardly spaced from the upper end 538a of the electrode assembly by a first length h7 along the longitudinal direction (y-axis direction) of the electrode assembly, and may be inwardly spaced from the lower end 538d of the electrode assembly by a second length h8 along the longitudinal direction (y-axis direction) of the electrode assembly. The adhesive member 537 may be inwardly spaced from the left end 538c of the electrode assembly by a third length h5 along the width direction (x-axis direction) of the electrode assembly, and may be inwardly spaced from the right end 538b of the electrode assembly by a third length h6 along the width direction (x-axis direction) of the electrode assembly.

In some embodiments, the first length h3, the second length h4, and the third lengths h1 and h2 may be the same (or substantially the same), may be different from each other, or may be only partially different (e.g., different in some respects and the same in some respects).

In some embodiments, the first length h7 and the second length h8 may be longer than the third lengths h5 and h6. With regard to the third lengths h5 and h6, the length h5 from the left end 538c and the length h6 from the right end 538b may be the same (or substantially the same), or may be different from each other.

According to some embodiments, the first length h7, the second length h8, and the third lengths h5 and h6 may be longer than the length of the tape in the longitudinal direction (y-axis direction).

According to some embodiments, the secondary battery may further include the upper tape 541 and the lower tape 533 that are attached to the upper end 538a and the lower end 538d, respectively, along the longitudinal direction (y-axis direction) of the electrode assembly. In some embodiments, the adhesive member 537 may overlap the upper tape 541 and the lower tape 533 in the thickness direction (z-axis direction). However, in some embodiments, the adhesive member 537 may only partially overlap the upper tape 541 and the lower tape 533.

According to some embodiments, the secondary battery may further include side tapes that are attached to the left end 538c and the right end 538b, respectively, and the adhesive member 537 may overlap the side tapes in the thickness direction (z-axis direction). However, in some embodiments, the adhesive member 537 may only partially overlap the side tapes.

According to some embodiments, in an embodiment in which the adhesive member 537 includes a binder, because the binder may have a thickness in a range from approximately 3 μm to approximately 5 μm, the overlap with the side tapes does not significantly affect the thickness of the cell. Thus, the adhesive member 537 may overlap the side tapes. With this configuration, a contact area between the electrode assembly and the adhesive member 537 can be maximized, and the adhesive strength can be improved. Thereby, it is possible to solve a problem in which the electrode assembly moves inside the case due to a falling impact of the battery (i.e., the configuration of the adhesive member and the tapes is configured to prevent or at least mitigate the electrode assembly from moving inside the case due to a falling impact, which might otherwise damage the secondary battery).

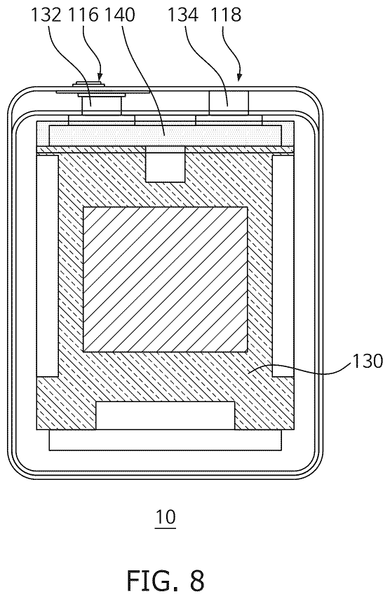

FIG. 8 is a projection view of a secondary battery illustrating an example of an insulator according to some embodiments of the present disclosure.

The positive electrode terminal 116 that is electrically connected to a positive electrode tab 132 of the electrode assembly 130 and the negative electrode terminal 118 that is electrically connected to a negative electrode tab 134 of the electrode assembly 130 may be connected to the lower case 110. In one or more embodiments, the electrode terminals 116 and 118 may be on at least one side of the lower case 110.

In some embodiments, the secondary battery 10 may further include an insulator 140 disposed between the electrode terminals 116 and 118 and the electrode assembly 130. The insulator 140 may be disposed in close contact with the electrode assembly 130, but is not limited thereto.

In some embodiments, the center of the insulator 140 may be aligned (or substantially aligned) with the center of the electrode assembly 130 in the widthwise direction (x-axis direction), and an area of the insulator 140 may be aligned (or substantially aligned) with an area of the side of the electrode assembly 130 facing the insulator 140.

With this configuration, it is possible to prevent (or at least mitigate) a short circuit due to movement of the electrode assembly 130. Further, the secondary battery may further include the insulator 140, and thus, it is possible to further reduce movement of the electrode assembly 130 inside the cell compared to a related art pouch cell. Furthermore, it is possible to doubly prevent movement of the electrode assembly in the longitudinal direction due to the double-sided adhesive members applied to the electrode assembly.

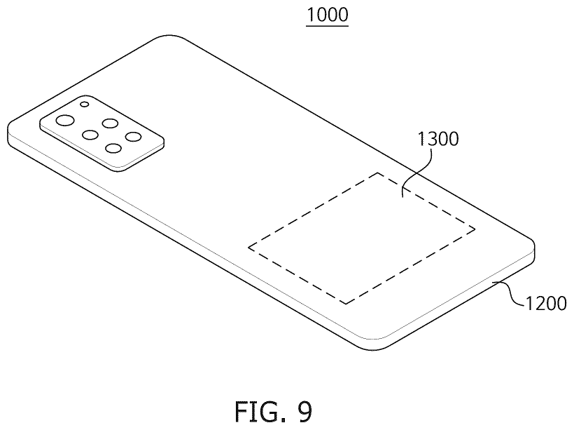

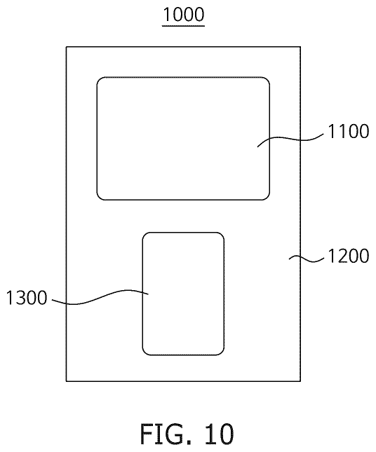

FIG. 9 is a diagram schematically illustrating a battery electronic device according to some embodiments of the present disclosure. FIG. 10 is a diagram illustrating a secondary battery in the battery electronic device according to some embodiments of the present disclosure.

Referring to FIG. 9 and FIG. 10, a battery electronic device 1000 according to some embodiments of the present disclosure may include an operation unit 1100 that performs a predetermined operation, a housing 1200 that accommodates the operation unit 1100 therein, and a secondary battery 1300 that is fixed inside the housing 1200 and supplies power to the operation unit 1100.

The battery electronic device 1000 including the secondary battery 1300 may be a smart phone, but the present disclosure is not limited thereto. The battery electronic device 1000 may be used in various devices that use electric energy stored in the secondary battery 1300 and require a protection circuit.

The operation unit 1100 may include various hardware that is driven by electric energy supplied from the secondary battery 1300. For example, the operation unit 1100 may include an application processor (AP), a central process unit (CPU), and the like of a portable electronic device.

According to some embodiments, a printed circuit board including signal transmission wiring may be inside the housing 1200, and the operation unit 1100 may be provided on the printed circuit board so as to be electrically connected to other components of the battery electronic device 1000.

The housing 1200 may accommodate the operation unit 1100 and the secondary battery 1300 therein and may form an outer appearance of the battery electronic device 1000. The housing 1200 may be provided in various structural forms in which the housing 1200 can support the operation unit 1100 and the secondary battery 1300 therein and can protect the operation unit 1100 and the secondary battery 1300 from external impact.

The secondary battery 1300 may be fixed inside the housing 1200 and may stably supply power to the operation unit 1100. The secondary battery 1300 may have substantially the same configuration as the secondary battery 10 described with reference to FIG. 1 to FIG. 8.

For example, the secondary battery 1300 may be in a power supply area inside the housing 1200, and it may be connected to a terminal of a printed circuit board. Thereby, the operation unit 1100 may be driven using the electric energy stored in the first battery cell and the second battery cell.

In some embodiments, the upper case of the secondary battery 1300 may include one or more screw tabs to which screws are fastened. The one or more screw taps may be provided in the housing 1200.

In some embodiments, the electronic device 1000 may further include a double-sided tape 1310 between the secondary battery and the housing such that the secondary battery 1300 is mounted in the housing. The secondary battery 1300 may be mounted in the housing by the double-sided tape 1310.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### EXPLANATION OF REFERENCE SYMBOLS

10: secondary battery
100: case
110: Lower case
112: accommodating portion
114a, 114b, 114c, 114d: flange
116, 118: Electrode terminal
120: Upper case
130: Electrode assembly
132: anode tab
134: cathode tab

What is claimed is:

1. A secondary battery comprising:
an electrode assembly comprising a first electrode, a second electrode, and a separator;
a lower case accommodating the electrode assembly;
an upper case coupled to the lower case;
a first adhesive member between the lower case and the electrode assembly such that the lower case and the electrode assembly are adhered to each other; and
a second adhesive member between the upper case and the electrode assembly such that the upper case and the electrode assembly are adhered to each other,
wherein materials of the first adhesive member and the second adhesive member are different from each other.

2. The secondary battery according to claim 1, wherein each of the first adhesive member and the second adhesive member is on an inner side of the electrode assembly in a width direction and a longitudinal direction of the electrode assembly.

3. The secondary battery according to claim 2, wherein a center of the electrode assembly in the width direction is substantially aligned with a center of each of the first adhesive member and the second adhesive member in the width direction.

4. The secondary battery according to claim 1, wherein the first adhesive member comprises a binder, and wherein the second adhesive member comprises an OPS tape.

5. The secondary battery according to claim 4, further comprising an electrolyte injection port in the lower case, wherein a center of the second adhesive member and the electrolyte injection port are on opposite sides of a center of the electrode assembly.

6. The secondary battery according to claim 5, wherein the second adhesive member and the electrolyte injection port are on opposite sides of the center of the electrode assembly along a longitudinal direction or a width direction of the electrode assembly.

7. The secondary battery according to claim 4, wherein:
the second adhesive member is inwardly spaced from an upper end of the electrode assembly by a first length along a longitudinal direction of the electrode assembly,
the second adhesive member is inwardly spaced from a lower end of the electrode assembly by a second length along the longitudinal direction of the electrode assembly,
the second adhesive member is inwardly spaced from left and right ends of the electrode assembly by a third length along a width direction of the electrode assembly, and
the first length and the second length are longer than the third length.

8. The secondary battery according to claim 4, further comprising:
an upper tape and a lower tape that are respectively attached to an upper portion and a lower portion of the electrode assembly along a longitudinal direction of the electrode assembly,
wherein the second adhesive member does not overlap the upper tape and the lower tape in a thickness direction.

9. The secondary battery according to claim 1, wherein the first adhesive member comprises an OPS tape, and wherein the second adhesive member comprises a binder.

10. The secondary battery according to claim 9, further comprising an electrolyte injection port in the lower case, and wherein a center of the first adhesive member and the electrolyte injection port are on opposite sides of a center of the electrode assembly.

11. The secondary battery according to claim 10, wherein the first adhesive member and the electrolyte injection port are on opposite sides of the center of the electrode assembly along a longitudinal direction or a width direction of the electrode assembly.

12. The secondary battery according to claim 9, wherein:
the first adhesive member is inwardly spaced from an upper end of the electrode assembly by a first length along a longitudinal direction of the electrode assembly,
the first adhesive member is inwardly spaced from a lower end of the electrode assembly by a second length along the longitudinal direction of the electrode assembly,
the first adhesive member is inwardly spaced from left and right ends of the electrode assembly by a third length along a width direction of the electrode assembly, and
the first length and the second length are longer than the third length.

13. The secondary battery according to claim 9, further comprising:
an upper tape and a lower tape that are respectively attached to an upper portion and a lower portion of the electrode assembly along a longitudinal direction of the electrode assembly,
wherein the first adhesive member does not overlap the upper tape and the lower tape in a thickness direction.

14. The secondary battery according to claim 1, wherein a thickness of one of the first adhesive member or the second adhesive member is in a range from approximately 3μ to approximately 5 μm, and wherein a thickness of another of the first adhesive member or the second adhesive member is approximately 50 μm.

15. The secondary battery according to claim 1, further comprising:
electrode terminals on the lower case, and an insulator between the electrode terminals and the electrode assembly.

16. The secondary battery according to claim 1, wherein the lower case and the upper case comprise stainless steel (SUS).

17. The secondary battery according to claim 1, wherein the upper case comprises one or more screw tabs configured to be fastened by screws.

18. An electronic device comprising:
an operation unit configured to perform predetermined operations;
a housing accommodating the operation unit therein such that the operation unit is fixed; and
a secondary battery fixed inside the housing and configured to supply power to the operation unit,
wherein the secondary battery comprises:
an electrode assembly;
a lower case accommodating the electrode assembly;
an upper case coupled to the lower case;
a first adhesive member between the lower case and the electrode assembly such that the lower case and the electrode assembly are adhered to each other; and
a second adhesive member between the upper case and the electrode assembly such that the upper case and the electrode assembly are adhered to each other, and
wherein materials of the first adhesive member and the second adhesive member are different from each other.

19. The electronic device according to claim 18, wherein the upper case comprises one or more screw tabs configured to be fastened by screws, and wherein the one or more screw tabs are in the housing.

20. The electronic device according to claim 18, further comprising a double-sided tape between the secondary battery and the housing such that the secondary battery is mounted in the housing.
